(19) United States
(12) Patent Application Publication
(10) Pub. No.: US 2020/0067169 A1
(43) Pub. Date: Feb. 27, 2020

(54) Method and System for Implementing Non-Line-Of-Sight Radio Antenna Alignment

(71) Applicant: CenturyLink Intellectual Property LLC, Broomfield, CO (US)

(72) Inventors: Sujeong Jang, Monroe, LA (US); Selma Sheikh-khalil, Oxford, GA (US)

(21) Appl. No.: 16/210,197

(22) Filed: Dec. 5, 2018

Related U.S. Application Data
(60) Provisional application No. 62/722,295, filed on Aug. 24, 2018.

(51) Int. Cl. H01Q 1/12; H01Q 3/04; H01Q 3/00

(52) U.S. Cl. CPC H01Q 1/1257; H01Q 3/005; H01Q 3/04

(57) ABSTRACT

Novel tools and techniques are provided for implementing non-line-of-sight radio antenna alignment. In various embodiments, a computing system might receive first and second signals from first and second sensors. The first and second sensors might be attached to a first antenna and disposed apart from each other along a horizontal plane that is perpendicular to a direction from which the first antenna receives signals from a second antenna located a distance away. The computing system might analyze the first and second signals to determine which signal is stronger, and, based on a determination that one signal is greater than the other, might send a first output signal indicating to rotate the first antenna horizontally about a vertical axis toward the second antenna and might repeat the receiving and analyzing processes until a difference between the first and second signals has been reduced to within a predetermined threshold similarity value.

### CROSS-REFERENCES TO RELATED APPLICATIONS

This application claims priority to U.S. Patent Application Ser. No. 62/722,295 (the “'295 application”), filed Aug. 24, 2018 by Sujeong Jang et al. (attorney docket no. 1508-US-P1), entitled, “Method and System for Implementing Non-Line-Of-Sight Radio Antenna Alignment,” which is incorporated herein by reference in its entirety for all purposes.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing radio antenna alignment, and, more particularly, to methods, systems, and apparatuses for implementing non-line-of-sight radio antenna alignment.

### BACKGROUND

Traditionally, antenna alignment requires measuring (and displaying) signal amplitude received by the antenna and manually changing orientation of the antenna to increase the measured signal amplitude. This process is tedious and time consuming, and may leave room for inaccuracies due to manual manipulation of the antenna's orientation. Even if mechanized systems are used to change the orientation, such mechanized systems are changed in response to inputs by a user based on the user's observation of the measured (and displayed) signal amplitude.

In some cases, manual antenna alignment might require line of sight by the user at least to “eye-ball” the initial alignment. However, if objects, buildings, tress, etc. are disposed between the antenna being aligned and a second antenna positioned a distance away, such initial alignment is made extremely difficult if not impossible, thus leading to a greater number of iterations of signal amplitude measurements and manual orientation changes of the antenna based on the measured signal amplitude.

Hence, there is a need for more robust and scalable solutions for implementing radio antenna alignment, and, more particularly, to methods, systems, and apparatuses for implementing non-line-of-sight radio antenna alignment.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing radio antenna alignment, in accordance with various embodiments.

FIGS. 2A and 2B are schematic diagrams illustrating various embodiments of circuits that may be used for implementing radio antenna alignment.

FIGS. 3A-3D are schematic diagrams illustrating various orientations of a system for implementing horizontal and vertical radio antenna alignment.

FIGS. 4A-4F are schematic diagrams illustrating various embodiments of systems that may be used for implementing radio antenna alignment.

FIGS. 5A-5D are flow diagrams illustrating a method for implementing radio antenna alignment, in accordance with various embodiments.

FIG. 6 is a block diagram illustrating an exemplary computer or system hardware architecture, in accordance with various embodiments.

FIG. 7 is a block diagram illustrating a networked system of computers, computing systems, or system hardware architecture, which can be used in accordance with various embodiments.

### DETAILED DESCRIPTION OF CERTAIN EMBODIMENTS

### Overview

Various embodiments provide tools and techniques for implementing radio antenna alignment, and, more particularly, to methods, systems, and apparatuses for implementing non-line-of-sight radio antenna alignment.

In various embodiments, a computing system might receive a first signal from a first sensor and a second signal from a second sensor. The first sensor and the second sensor might be attached to a first antenna and disposed apart from each other along a horizontal plane that is perpendicular to a direction from which the first antenna receives signals. The first signal and the second signal might be generated in response to receiving an original signal that is transmitted from a second antenna that is physically located a distance away from the first antenna. The computing system might analyze the first signal and the second signal to determine which signal is stronger, and, based on a determination that one of the first signal and the second signal is greater than the other, might send a first output signal indicating to rotate the first antenna horizontally about a vertical axis toward the second antenna and might repeat the receiving and analyzing processes until a difference between the first signal and the second signal has been reduced to within a predetermined threshold similarity value (e.g., to within 1%, within 0.5%, within 0.4%, within 0.3%, within 0.2%, within 0.1%, or less, of the signal amplitude of one of the first and second signals).

Similarly, the computing system might receive (from the second antenna) a third signal from the third sensor and a fourth signal from the fourth sensor, might analyze the third signal and the fourth signal to determine which signal is stronger, and, based on a determination that one of the third signal and the fourth signal is greater than the other, might send a second output signal indicating to rotate the first antenna vertically about a horizontal axis toward the second antenna and might repeat the receiving and analyzing processes until a difference between the third signal and the fourth signal has been reduced to within a predetermined threshold similarity value (e.g., to within 1%, within 0.5%, within 0.4%, within 0.3%, within 0.2%, within 0.1%, or less, of the signal amplitude of one of the first and second signals).

In some embodiments, the computing system might include, without limitation, at least one of a microprocessor, a microcontroller, a processor, a portable computer, a server, a distributed computing system, or a cloud-based computing system, and/or the like. In some cases, the first sensor and the second sensor might be radio frequency (“rf”) sensors, where the original signal might be a rf signal. According to some embodiments, the rf sensors might comprise at least one of one or more germanium diode rf detectors, one or more silicon rf detectors, one or more Schottky diode rf detectors, one or more gallium arsenide rf detectors, or one or more copper wires, and/or the like. In some instances, the first antenna (and in some cases, the second antenna as well) might include, but is not limited to, at least one of a parabolic reflector-based antenna, a Yagi-Uda antenna, a beam antenna, a parasitic array antenna, a loop antenna, a dipole antenna, or a monopole antenna, and/or the like.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, antenna signal detection system, antenna alignment system, and/or the like. In other aspects, certain embodiments, can improve the functioning of user equipment or systems themselves (e.g., antenna signal detectors, antenna alignment systems, etc.), for example, by receiving, with a computing system, a first signal from a first sensor and a second signal from a second sensor, the first sensor and the second sensor being attached to a first antenna and disposed apart from each other along a horizontal plane that is perpendicular to a direction from which the first antenna receives signals, the first signal and the second signal being generated in response to receiving an original signal that is transmitted from a second antenna that is physically located a distance away from the first antenna; analyzing, with the computing system, the first signal and the second signal to determine which signal is stronger; based on a determination that one of the first signal and the second signal is greater than the other, sending, with the computing system, a first output signal indicating to rotate the first antenna horizontally about a vertical axis toward the second antenna, and repeating the receiving and analyzing processes until a difference between the first signal and the second signal has been reduced to within a predetermined threshold similarity value; receiving, with the computing system, a third signal from a third sensor and a fourth signal from a fourth sensor, the third sensor and the fourth sensor being attached to the first antenna and disposed apart from each other along a vertical plane that is perpendicular to the direction from which the first antenna receives signals, the third signal and the fourth signal being generated in response to receiving the original signal that is transmitted from the second antenna; analyzing, with the computing system, the third signal and the fourth signal to determine which signal is stronger; and based on a determination that one of the first signal and the second signal is greater than the other, sending, with the computing system, a first output signal indicating to rotate the first antenna horizontally about a vertical axis toward the second antenna, and repeating the receiving and analyzing processes until a difference between the first signal and the second signal has been reduced to within a predetermined threshold similarity value; and/or the like.

In particular, to the extent any abstract concepts are present in the various embodiments, those concepts can be implemented as described herein by devices, software, systems, and methods that involve specific novel functionality (e.g., steps or operations), such as, using a first set of sensors spaced apart along a horizontal plane that is perpendicular to a direction from which a first antenna receives signals and (optionally) using a second set of sensors spaced apart along a vertical plane that is perpendicular to the direction from which the first antenna receives signal, and analyzing signals received from the first and second sets of sensors in response to an original signal from a second antenna located a distance away from the first antenna to determine which signals (i.e., from which direction) are greater along the horizontal direction and (optionally) along the vertical direction. Based on a determination that at least one of a first set of signals from the first set of sensors is greater than another, the system might send a first output signal indicating to rotate the first antenna horizontally about a vertical axis toward the second antenna, and might repeat the receiving and analyzing processes until a difference(s) among the first set of signals has been reduced to within a predetermined threshold similarity value. Based on a determination that at least one of a second set of signals from the second set of sensors is greater than another, the system might send a second output signal indicating to rotate the second antenna vertically about a horizontal axis toward the second antenna, and might repeat the receiving and analyzing processes until a difference(s) among the second set of signals has been reduced to within a predetermined threshold similarity value. These are but a few examples that extend beyond mere conventional computer processing operations. These functionalities can produce tangible results outside of the implementing computer system, including, merely by way of example, optimized alignment of antennas, and/or the like, at least some of which may be observed or measured by users and/or service providers.

In an aspect, a method might comprise receiving, with a computing system, a first signal from a first sensor and a second signal from a second sensor, the first sensor and the second sensor being attached to a first antenna and disposed apart from each other along a horizontal plane that is perpendicular to a direction from which the first antenna receives signals, the first signal and the second signal being generated in response to receiving an original signal that is transmitted from a second antenna that is physically located a distance away from the first antenna. The method might also comprise analyzing, with the computing system, the first signal and the second signal to determine which signal is stronger. The method might further comprise, based on a determination that one of the first signal and the second signal is greater than the other, sending, with the computing system, a first output signal indicating to rotate the first antenna horizontally about a vertical axis toward the second antenna, and repeating the receiving and analyzing processes until a difference between the first signal and the second signal has been reduced to within a predetermined threshold similarity value.

In some embodiments, the computing system might comprise at least one of a microprocessor, a microcontroller, a processor, a portable computer, a server, a distributed computing system, or a cloud-based computing system, and/or the like. In some cases, the first sensor and the second sensor might be radio frequency (“rf”) sensors and wherein the original signal is a rf signal.

According to some embodiments, sending the first output signal might comprise sending the first output signal to a display device to indicate to a user which horizontal direction to manually rotate the first antenna horizontally about the vertical axis toward the second antenna. Alternatively, or additionally, sending the first output signal might comprise sending the first output signal to a motorized actuator that automatically causes the first antenna to rotate horizontally about the vertical axis toward the second antenna.

In some embodiments, the method might further comprise receiving, with the computing system, a third signal from a third sensor and a fourth signal from a fourth sensor, the third sensor and the fourth sensor being attached to the first antenna and disposed apart from each other along a vertical plane that is perpendicular to the direction from which the first antenna receives signals, the third signal and the fourth signal being generated in response to receiving the original signal that is transmitted from the second antenna. The method might also comprise analyzing, with the computing system, the third signal and the fourth signal to determine which signal is stronger. The method might further comprise, based on a determination that one of the third signal and the fourth signal is greater than the other, sending, with the computing system, a second output signal indicating to rotate the first antenna vertically about a horizontal axis toward the second antenna, and repeating the receiving and analyzing processes until a difference between the third signal and the fourth signal has been reduced to within the predetermined threshold similarity value.

According to some embodiments, sending the second output signal might comprise sending the second output signal to a display device to indicate to a user which vertical direction to manually rotate the first antenna vertically about the horizontal axis toward the second antenna. Alternatively, or additionally, sending the second output signal might comprise sending the second output signal to a motorized actuator that automatically causes the first antenna to rotate vertically about the horizontal axis toward the second antenna.

In another aspect, an antenna alignment device might comprise at least one processor and a non-transitory computer readable medium communicatively coupled to the at least one processor. The non-transitory computer readable medium might have stored thereon computer software comprising a set of instructions that, when executed by the at least one processor, causes the antenna alignment device to: receive a first signal from a first sensor and a second signal from a second sensor, the first sensor and the second sensor being attached to a first antenna and disposed apart from each other along a horizontal plane that is perpendicular to a direction from which the first antenna receives signals, the first signal and the second signal being generated in response to receiving an original signal that is transmitted from a second antenna that is physically located a distance away from the first antenna; analyze the first signal and the second signal to determine which signal is stronger; and based on a determination that one of the first signal and the second signal is greater than the other, send a first output signal indicating to rotate the first antenna horizontally about a vertical axis toward the second antenna, and repeat the receiving and analyzing processes until a difference between the first signal and the second signal has been reduced to within a predetermined threshold similarity value.

In some embodiments, the antenna alignment device might comprise at least one of a microprocessor, a microcontroller, a processor, a portable computer, a server, a distributed computing system, or a cloud-based computing system, and/or the like. In some cases, the first sensor and the second sensor might be radio frequency (“rf”) sensors and wherein the original signal is a rf signal. In some instances, the rf sensors comprise at least one of one or more germanium diode rf detectors, one or more silicon rf detectors, one or more Schottky diode rf detectors, one or more gallium arsenide rf detectors, or one or more copper wires, and/or the like. In some cases, the first antenna might comprise at least one of a parabolic reflector-based antenna, a Yagi-Uda antenna, a beam antenna, a parasitic array antenna, a loop antenna, a dipole antenna, or a monopole antenna, and/or the like.

According to some embodiments, sending the first output signal might comprise sending the first output signal to a display device to indicate to a user which horizontal direction to manually rotate the first antenna horizontally about the vertical axis toward the second antenna. Alternatively, or additionally, sending the first output signal might comprise sending the first output signal to a motorized actuator that automatically causes the first antenna to rotate horizontally about the vertical axis toward the second antenna.

In some embodiments, the set of instructions, when executed by the at least one processor, further causes the apparatus to: receive a third signal from a third sensor and a fourth signal from a fourth sensor, the third sensor and the fourth sensor being attached to the first antenna and disposed apart from each other along a vertical plane that is perpendicular to the direction from which the first antenna receives signals, the third signal and the fourth signal being generated in response to receiving the original signal that is transmitted from the second antenna; analyze the third signal and the fourth signal to determine which signal is stronger; and based on a determination that one of the third signal and the fourth signal is greater than the other, send a second output signal indicating to rotate the first antenna vertically about a horizontal axis toward the second antenna, and repeat the receiving and analyzing processes until a difference between the third signal and the fourth signal has been reduced to within the predetermined threshold similarity value.

According to some embodiments, sending the second output signal might comprise sending the second output signal to a display device to indicate to a user which vertical direction to manually rotate the first antenna vertically about the horizontal axis toward the second antenna. Alternatively, or additionally, sending the second output signal might comprise sending the second output signal to a motorized actuator that automatically causes the first antenna to rotate vertically about the horizontal axis toward the second antenna.

In yet another aspect, an antenna alignment system might comprise a first sensor; a second sensor; and a computing system. The computing system might comprise at least one processor and a non-transitory computer readable medium communicatively coupled to the at least one processor. The non-transitory computer readable medium might have stored thereon computer software comprising a set of instructions that, when executed by the at least one processor, causes the computing system to: receive a first signal from the first sensor and a second signal from the second sensor, the first sensor and the second sensor being attached to a first antenna and disposed apart from each other along a horizontal plane that is perpendicular to a direction from which the first antenna receives signals, the first signal and the second signal being generated in response to receiving an original signal that is transmitted from a second antenna that is physically located a distance away from the first antenna; analyze the first signal and the second signal to determine which signal is stronger; and based on a determination that one of the first signal and the second signal is greater than the other, send a first output signal indicating to rotate the first antenna horizontally about a vertical axis toward the second antenna, and repeat the receiving and analyzing processes until a difference between the first signal and the second signal has been reduced to within a predetermined threshold similarity value.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

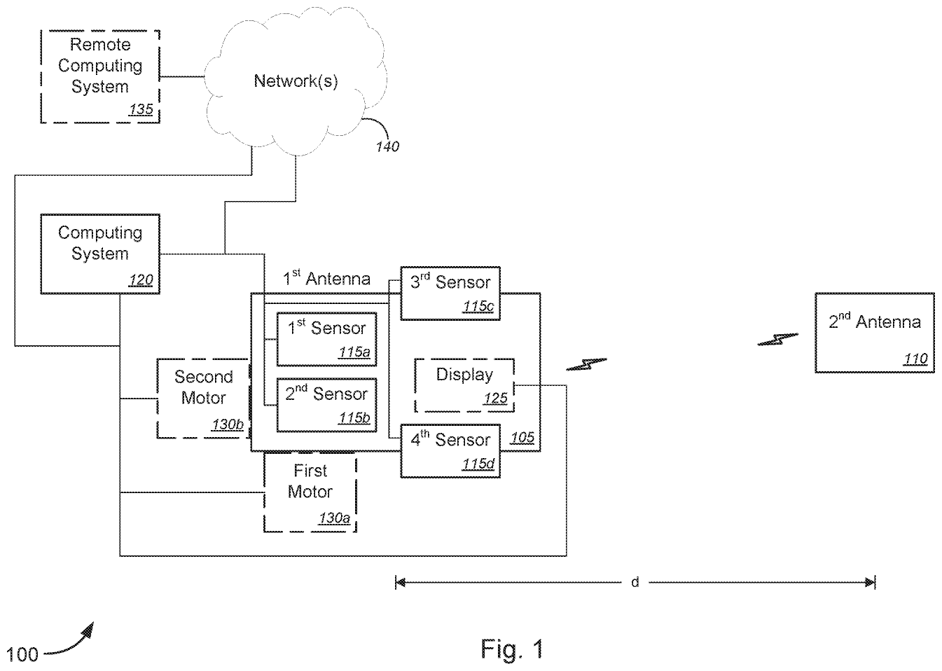

We now turn to the embodiments as illustrated by the drawings. FIGS. 1-7 illustrate some of the features of the method, system, and apparatus for implementing radio antenna alignment, and, more particularly, to methods, systems, and apparatuses for implementing non-line-of-sight radio antenna alignment, as referred to above. The methods, systems, and apparatuses illustrated by FIGS. 1-7 refer to examples of different embodiments that include various components and steps, which can be considered alternatives or which can be used in conjunction with one another in the various embodiments. The description of the illustrated methods, systems, and apparatuses shown in FIGS. 1-7 is provided for purposes of illustration and should not be considered to limit the scope of the different embodiments.

With reference to the figures, FIG. 1 is a schematic diagram illustrating a system 100 for implementing radio antenna alignment, in accordance with various embodiments.

In the non-limiting embodiment of FIG. 1, system 100 might comprise a first antenna 105 and a second antenna 110, the second antenna 110 being physically located a (lateral) distance away from the first antenna 105 (e.g., greater than 50 m (˜55 yards), greater than 100 m (˜109 yards), greater than 150 m (˜164 yards), greater than 200 m (˜219 yards), greater than 250 m (˜273 yards), greater than 300 m (˜328 yards), greater than 350 m (˜383 yards), greater than 400 m (˜437 yards), greater than 450 m (˜492 yards), greater than 500 m (˜547 yards), greater than 550 m (˜601 yards), greater than 600 m (˜656 yards), greater than 650 m (˜711 yards), greater than 700 m (˜766 yards), greater than 750 m (˜820 yards), greater than 800 m (˜875 yards), greater than 850 m (˜930 yards), greater than 900 m (˜984 yards), greater than 950 m (˜1,039 yards), greater than 1 km (˜1,094 yards), or greater). In some instances, the second antenna may not be in line of sight of the first antenna (and in some cases, might be visually or physically obscured by parts of buildings, trees, mountains, or other structures, and/or the like).

System 100 might further comprise a first sensor 115a, a second sensor 115b, a third sensor 115c, and a fourth sensor 115d (collectively, “sensors 115” or the like), each of which might be attached to the first antenna (in some cases, being removably attached to the first antenna or alternatively being permanently attached to the first antenna). In some cases, the first sensor 115a and the second sensor 115b, while attached to the first antenna 105, might be disposed apart from each other along a horizontal plane that is perpendicular to a direction from which the first antenna 105 receives signals (e.g., from the second antenna 110, as depicted by the lightning bolt symbol in FIG. 1). In some instances, the third sensor 115c and the fourth sensor 115d, while attached to the first antenna 105, might be disposed apart from each other along a vertical plane that is perpendicular to the direction from which the first antenna 105 receives signals (e.g., from the second antenna 110, as depicted by the lightning bolt symbol in FIG. 1). Although two sensors (i.e., first and second sensors 115a and 115b) are described as being disposed along the horizontal plane, and although two sensors (i.e., third and fourth sensors 115c and 115d) are described as being disposed along the vertical plane, the various embodiments are not so limited, and a set of three or more sensors may be disposed along the horizontal plane and/or a set of three or more sensors may be disposed along the vertical plane.

According to some embodiments, each sensor 115 might be a radio frequency (“rf”) sensor, or the like. Merely by way of example, in some cases, the rf sensors might comprise at least one of one or more germanium diode rf detectors, one or more silicon rf detectors, one or more Schottky diode rf detectors, one or more gallium arsenide rf detectors, or one or more copper wires, and/or the like. In some instances, each of the first antenna 105 and the second antenna 110 might include, but is not limited to, at least one of a parabolic reflector-based antenna, a Yagi-Uda antenna, a beam antenna, a parasitic array antenna, a loop antenna, a dipole antenna, or a monopole antenna, and/or the like. Although the various embodiments are described herein in the context of rf detection and radio antenna alignment, the various embodiments are not so limited, and the various embodiments may be applicable to other forms of electromagnetic signal detection and other types of signal antenna alignment.

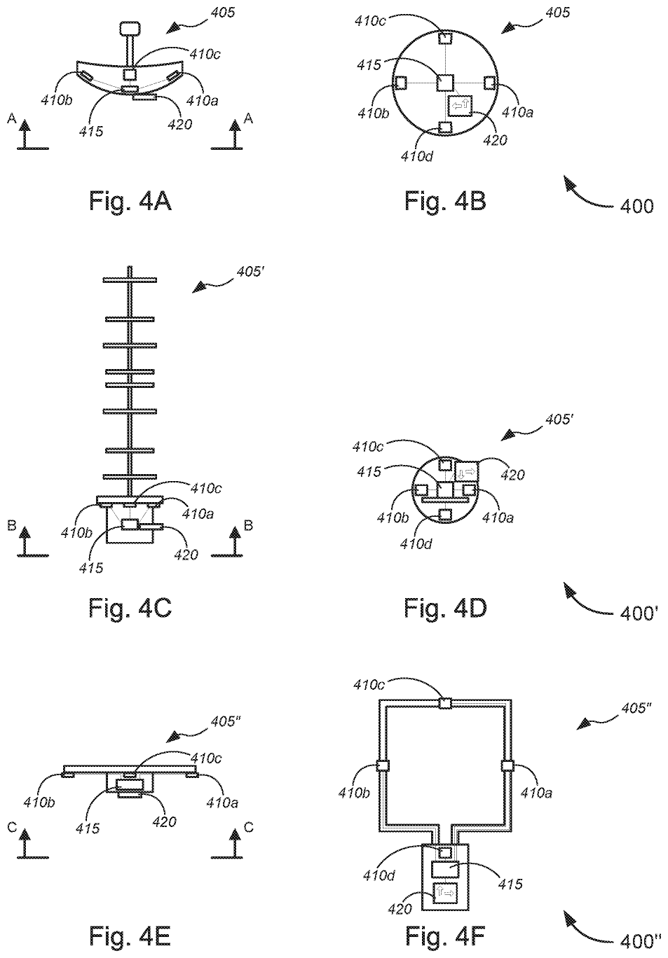

System 100 might also comprise a computing system 120, which might include, without limitation, at least one of a microprocessor, a microcontroller (e.g., an Arduino microcontroller, or the like), a processor, a portable computer (e.g., a Raspberry Pi single board computer, or the like), a server, a distributed computing system, or a cloud-based computing system, and/or the like. In some embodiments, system 100 might further comprise a display device 125, which might be permanently attached to the first antenna 105 (as shown, e.g., in the non-limiting embodiments of FIGS. 4A-4F, or the like). In some cases, the display device 125 might include, but is not limited to, at least one of a touchscreen display, a non-touchscreen display, a liquid crystal display (“LCD”), a light emitting diode (“LED”) display, an organic LED (“OLED”) display, and/or the like. Alternative, or additional, to the use of display device 125, system 100 might further comprise at least one of a first motor 130a and/or a second motor 130b. According to some embodiments, the first motor 130a and the second motor 130b might each include, without limitation, at least one of a motorized actuator, a stepper motor, a servo-motor, and/or the like. The first motor 130a might be coupled to the first antenna 105 to cause the first antenna 105 to rotate horizontally about a vertical axis, while the second motor 130b (if also present) might be coupled to the first antenna 105 to cause the first antenna 105 to rotate vertically about a horizontal axis.

In some embodiments, system 100 might optionally comprise a remote computing system 135 and network(s) 140, or the like. According to some embodiments, the computing system 120 (or remote computing system 135 via network(s) 140) might communicatively couple with at least one of the sensors 115, the display device 125, the first motor 130a, or the second motor 130b, and/or the like.

In operation, the computing system 120 might receive (from the second antenna 110 that is physically located a distance d away from the first antenna 105 (as depicted in FIG. 1)) a first signal from the first sensor 115a and a second signal from the second sensor 115b, might analyze the first signal and the second signal to determine which signal is stronger, and, based on a determination that one of the first signal and the second signal is greater than the other, might send a first output signal indicating to rotate the first antenna 105 horizontally about a vertical axis toward the second antenna 110 and might repeat the receiving and analyzing processes until a difference between the first signal and the second signal has been reduced to within a predetermined threshold similarity value (e.g., to within 1%, within 0.5%, within 0.4%, within 0.3%, within 0.2%, within 0.1%, or less, of the signal amplitude of one of the first and second signals). According to some embodiments, the distance d might be a lateral distance (i.e., not necessarily taking into account vertical distances between the first and second antennas 105 and 110), and might be greater than 50 m (˜55 yards), greater than 100 m (˜109 yards), greater than 150 m (˜164 yards), greater than 200 m (˜219 yards), greater than 250 m (˜273 yards), greater than 300 m (˜328 yards), greater than 350 m (˜383 yards), greater than 400 m (˜437 yards), greater than 450 m (˜492 yards), greater than 500 m (˜547 yards), greater than 550 m (˜601 yards), greater than 600 m (˜656 yards), greater than 650 m (˜711 yards), greater than 700 m (˜766 yards), greater than 750 m (˜820 yards), greater than 800 m (˜875 yards), greater than 850 m (˜930 yards), greater than 900 m (˜984 yards), greater than 950 m (˜1,039 yards), greater than 1 km (˜1,094 yards), or greater.

Similarly, the computing system 120 might receive (from the second antenna 110) a third signal from the third sensor 115c and a fourth signal from the fourth sensor 115d, might analyze the third signal and the fourth signal to determine which signal is stronger, and, based on a determination that one of the third signal and the fourth signal is greater than the other, might send a second output signal indicating to rotate the first antenna 105 vertically about a horizontal axis toward the second antenna 110 and might repeat the receiving and analyzing processes until a difference between the third signal and the fourth signal has been reduced to within a predetermined threshold similarity value (e.g., to within 1%, within 0.5%, within 0.4%, within 0.3%, within 0.2%, within 0.1%, or less, of the signal amplitude of one of the first and second signals).

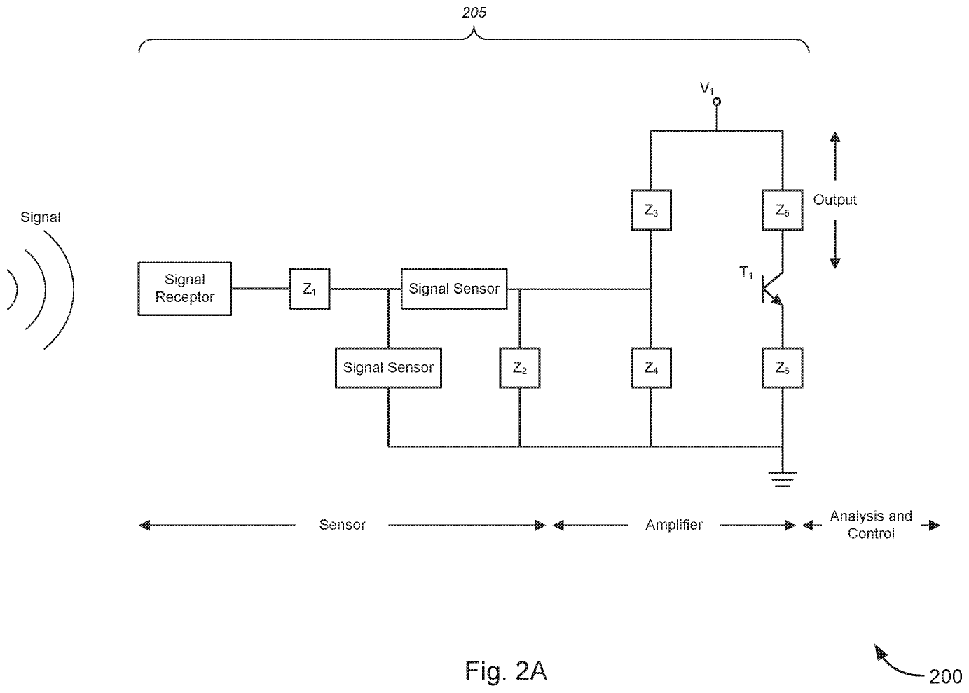

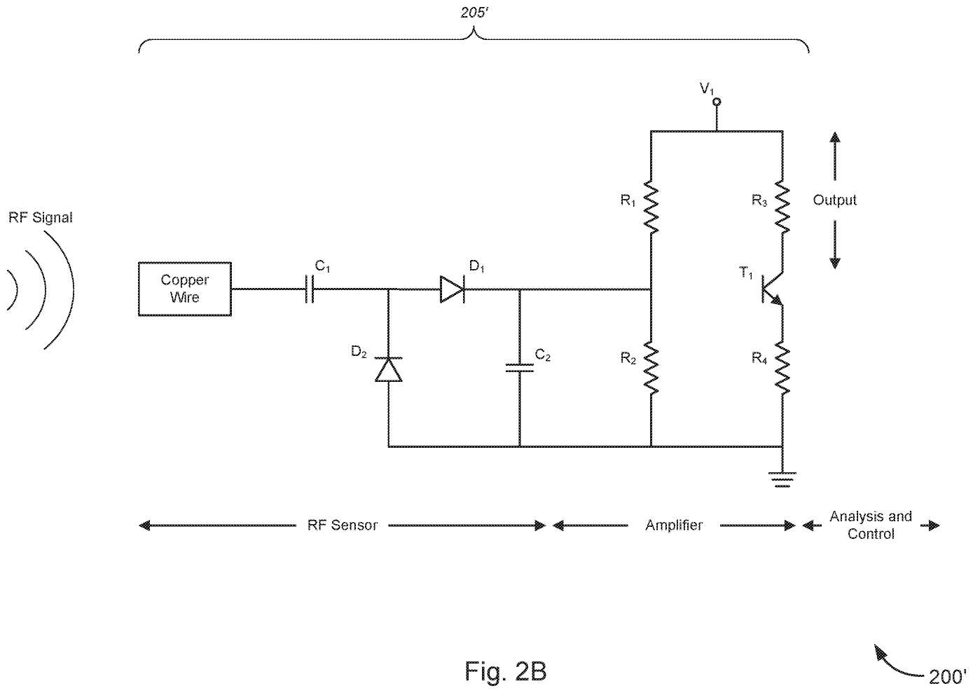

These and other functions of the system 100 (and its components) are described in greater detail below with respect to FIGS. 2A-5D.

FIGS. 2A and 2B (collectively, “FIG. 2”) are schematic diagrams illustrating various embodiments 200 and 200′ of circuits that may be used for implementing radio antenna alignment.

In the non-limiting embodiment 200 of FIG. 2A, circuit 205 might be used in one or more signal sensors, which might be embodied as one of the first through fourth sensors 115a-115d of FIG. 1, or the like. The circuit 205 might comprise a sensor portion, an amplifier portion, and an output portion. In some cases, the sensor portion might include, without limitation, one or more signal receptors, one or more signal sensors, one or more first impedance components, and/or the like. The one or more signal receptors might receive a signal (depicted by wave symbols in FIG. 2A), while the one or more signal sensors (when incorporated in a circuit configuration with the one or more first impedance components) might detect the signal as received by the one or more signal receptors. The amplifier portion—which might include, but is not limited to, one or more second impedance components, one or more transistors, one or more power sources (e.g., a battery, power outlet, solar power, a dedicated power source, etc.), and/or the like—might amplify the detected signal and might output the amplified signal (via the output portion) to the analysis and control system (e.g., computing system 120 of FIG. 1, or the like). In some cases, the signal might be one of any number of types of electromagnetic radiation or signal, while the signal receptor and signal sensors might be receptors and sensors configured to receive and detect the particular type of electromagnetic radiation or signal.

Although FIG. 2A depicts a particular configuration of each of the sensor portion, the amplifier portion, and the output portion in circuit 205, the various embodiments are not so limited and the circuit 205 might be configured in any manner as necessary to perform the processes of sensing, amplifying, and outputting signals.

With reference to FIG. 2B, the particular type of electromagnetic radiation or signal that is received or detected is radio frequency (“rf”) radiation or signal, or the like. In the non-limiting embodiment 200′ of FIG. 2B, circuit 205′ might be used in one or more rf signal sensors, which might be embodied as one of the first through fourth sensors 115a-115d of FIG. 1, or the like. The circuit 205′ might comprise a rf sensor portion, an amplifier portion, and an output portion. In some cases, the rf sensor portion might include, without limitation, one or more rf signal receptors, one or more rf signal sensors, one or more first impedance components, and/or the like. The one or more rf signal receptors—which might include, but is not limited to, one or more copper wires, or any other rf conductive material, or the like—might receive a rf signal (depicted by wave symbols in FIG. 2B), while the one or more rf signal sensors (when incorporated in a circuit configuration with the one or more first impedance components) might detect the rf signal as received by the one or more rf signal receptors. In some instances, the one or more rf signal sensors might include, without limitation, at least one of one or more germanium diode rf detectors, one or more silicon rf detectors, one or more Schottky diode rf detectors, or one or more gallium arsenide rf detectors, and/or the like. In some cases, the one or more first impedance components might comprise at least one of one or more capacitors (as shown in FIG. 2B), one or more resistors (not shown in FIG. 2B), or one or more inductors (not shown in FIG. 2B), or the like. The amplifier portion—which might include, but is not limited to, one or more second impedance components, one or more transistors, one or more power sources (e.g., a battery, power outlet, solar power, a dedicated power source, etc.), and/or the like—might amplify the detected rf signal and might output the amplified signal (via the output portion) to the analysis and control system (e.g., computing system 120 of FIG. 1, or the like). In some instances, the one or more second impedance components might comprise at least one of one or more resistors (as shown in FIG. 2B), one or more capacitors (not shown in FIG. 2B), or one or more inductors (not shown in FIG. 2B), or the like.

Although FIG. 2B depicts a particular configuration of each of the sensor portion, the amplifier portion, and the output portion in circuit 205′, the various embodiments are not so limited and the circuit 205′ might be configured in any manner as necessary to perform the processes of sensing, amplifying, and outputting.

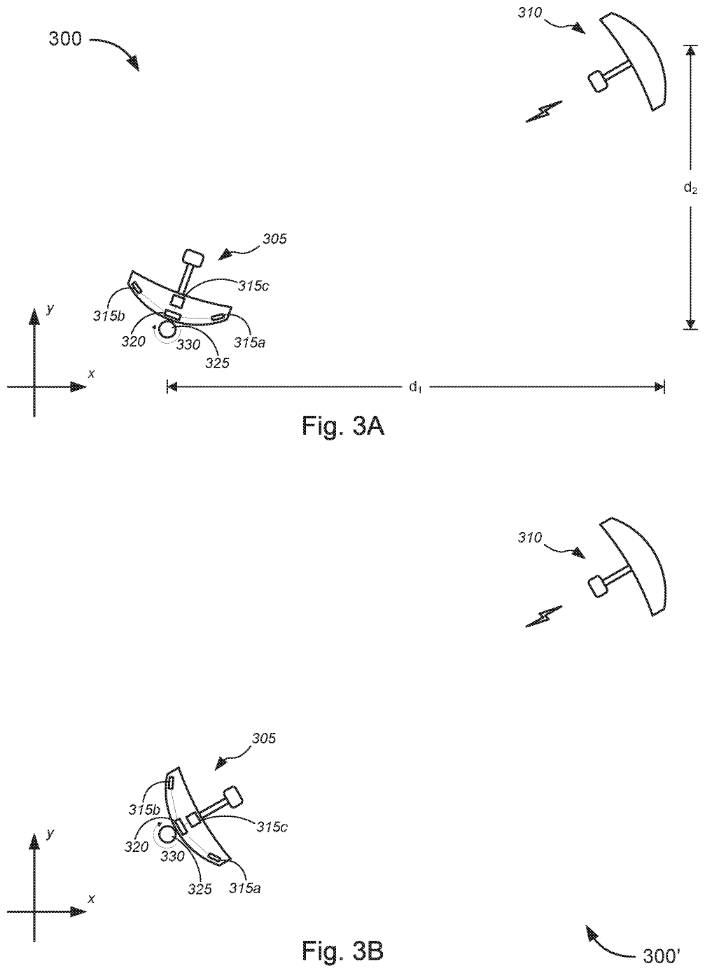

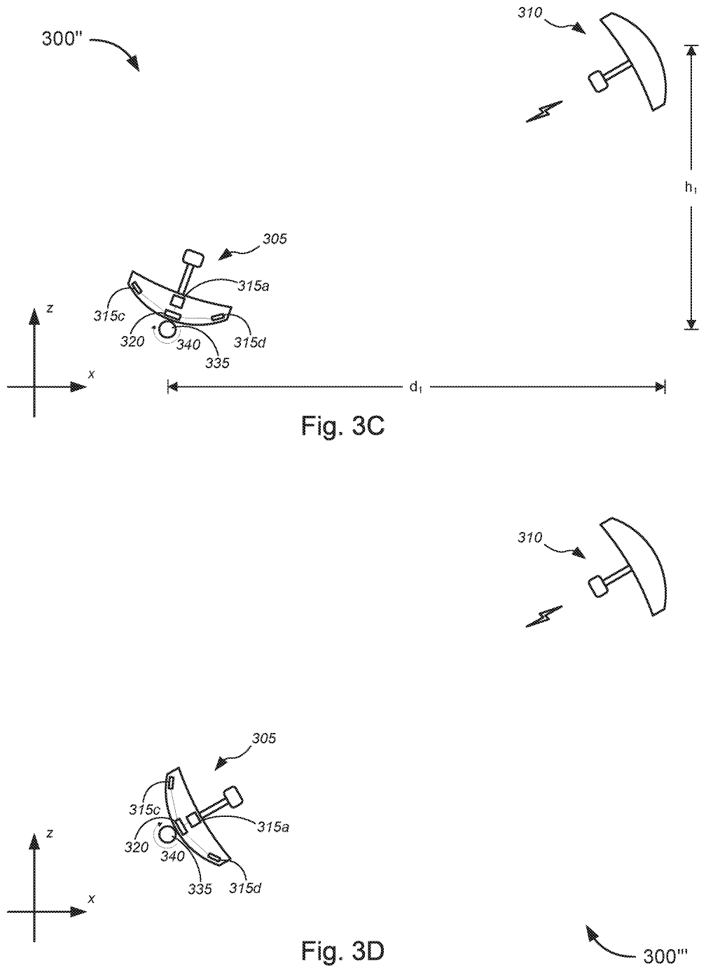

FIGS. 3A-3D (collectively, “FIG. 3”) are schematic diagrams illustrating various orientations 300, 300′, 300″, and 300″ of a system for implementing horizontal and vertical radio antenna alignment. FIGS. 3A and 3B depict a top plan view of two antennas, while FIGS. 3C and 3D depict a side elevation view of two antennas.

With reference to the non-limiting embodiment 300 of FIG. 3A, a first antenna 305 might receive signals from a second antenna 310. As depicted in FIG. 3A, the first antenna 305 might be disposed a distance d₁ along the x direction and disposed a distance d₂ along the y direction from the second antenna 310, where the square root of the sum of the squares of d₁ and d₂ is a (lateral) distance that is greater than 50 m (˜55 yards), greater than 100 m (˜109 yards), greater than 150 m (˜164 yards), greater than 200 m (˜219 yards), greater than 250 m (˜273 yards), greater than 300 m (˜328 yards), greater than 350 m (˜383 yards), greater than 400 m (˜437 yards), greater than 450 m (˜492 yards), greater than 500 m (˜547 yards), greater than 550 m (˜601 yards), greater than 600 m (˜656 yards), greater than 650 m (˜711 yards), greater than 700 m (˜766 yards), greater than 750 m (˜820 yards), greater than 800 m (˜875 yards), greater than 850 m (˜930 yards), greater than 900 m (˜984 yards), greater than 950 m (˜1,039 yards), greater than 1 km (˜1,094 yards), or greater. In some embodiments, a system might comprise one or more sensors 315a-315d (collectively, “sensors 315” or the like; although only sensors 315a-315c are shown in FIGS. 3A and 3B, while sensors 315a, 315c, and 315d are shown in FIGS. 3C and 3D), a computing system(s) 320, and/or the like.

A first sensor 315a and a second sensor 315b among the one or more sensors 315 might detect the signals transmitted from the second antenna 310, and might send a first signal and a second signal, respectively, to the computing system(s) 320. The computing system(s) 320—which might include, without limitation, at least one of a microprocessor, a microcontroller (e.g., an Arduino microcontroller, or the like), a processor, a portable computer (e.g., a Raspberry Pi single board computer, or the like), a server, a distributed computing system, or a cloud-based computing system, and/or the like—might receive the first signal from the first sensor 315a and the second signal from the second sensor 315b. As shown in FIG. 3A, the first sensor 315a and the second sensor 315b might be attached to the first antenna 305 and might be disposed apart from each other along a horizontal plane that is perpendicular to a direction from which the first antenna 305 receives signals, the first signal and the second signal being generated in response to receiving an original signal that is transmitted from the second antenna 310. The computing system 320 might analyze the first signal and the second signal to determine which signal is stronger. Based on a determination that one of the first signal and the second signal is greater than the other, the computing system 320 might send a first output signal indicating to rotate the first antenna 305 horizontally about a vertical axis (z-axis; shown in FIGS. 3C and 3D)—or rotated about a first post 325 (as depicted by curved arrow 330 in FIG. 3A)—toward the second antenna 310, and might repeat the receiving and analyzing processes until a difference between the first signal and the second signal has been reduced to within a predetermined threshold similarity value (e.g., to within 1%, within 0.5%, within 0.4%, within 0.3%, within 0.2%, within 0.1%, or less, of the signal amplitude of one of the first and second signals), such as shown in the embodiment 300′ of FIG. 3B.

According to some embodiments, sending the first output signal might comprise sending the first output signal to a display device to indicate to a user which horizontal direction to manually rotate the first antenna 305 horizontally about the vertical axis toward the second antenna 310. Alternatively, or additionally, sending the first output signal comprises sending the first output signal to a motorized actuator that automatically causes the first antenna 305 to rotate horizontally about the vertical axis toward the second antenna 310.

Referring to the non-limiting embodiment 300″ of FIG. 3C, the first antenna 305 might receive signals from the second antenna 310. As depicted in FIG. 3C, the first antenna 305 might be disposed the distance d₁ along the x direction and disposed a height hi along the z direction from the second antenna 310, where the distance between the first antenna 305 and the second antenna 310 is same as the (lateral) distance as described with respect to FIG. 3A.

A third sensor 315c and a fourth sensor 315d among the one or more sensors 315 might detect the signals transmitted from the second antenna 310, and might send a third signal and a fourth signal, respectively, to the computing system(s) 320. The computing system(s) 320 might receive the third signal from the third sensor 315c and the fourth signal from the fourth sensor 315d. As shown in FIG. 3C, the third sensor 315c and the fourth sensor 315d might be attached to the first antenna 305 and might be disposed apart from each other along a vertical plane that is perpendicular to the direction from which the first antenna 305 receives signals, the third signal and the fourth signal being generated in response to receiving an original signal that is transmitted from the second antenna 310. The computing system 320 might analyze the third signal and the fourth signal to determine which signal is stronger. Based on a determination that one of the third signal and the fourth signal is greater than the other, the computing system 320 might send a second output signal indicating to rotate the first antenna 305 vertically about a horizontal axis (y-axis; shown in FIGS. 3A and 3B)—or rotated about a second post 335 (as depicted by curved arrow 340 in FIG. 3C)—toward the second antenna 310, and might repeat the receiving and analyzing processes until a difference between the third signal and the fourth signal has been reduced to within a predetermined threshold similarity value (e.g., to within 1%, within 0.5%, within 0.4%, within 0.3%, within 0.2%, within 0.1%, or less, of the signal amplitude of one of the third and fourth signals), such as shown in FIG. 3D.

According to some embodiments, sending the second output signal might comprise sending the second output signal to the display device to indicate to a user which vertical direction to manually rotate the first antenna 305 vertically about the horizontal axis toward the second antenna 310. Alternatively, or additionally, sending the second output signal might comprise sending the second output signal to a motorized actuator that automatically causes the first antenna 305 to rotate vertically about the horizontal axis toward the second antenna 310.

FIGS. 4A-4F (collectively, “FIG. 4”) are schematic diagrams illustrating various embodiments of systems 400, 400′, and 400″ that may be used for implementing radio antenna alignment. In particular, FIG. 4 depicts radio antenna alignment systems that may be attached to various different types of radio antennas including, but not limited to, a parabolic reflector-based antenna (a non-limiting embodiment of which is shown in FIGS. 4A and 4B), a Yagi-Uda antenna (also referred to as a “Yagi antenna,” a beam antenna, or a parasitic array antenna, or the like; a non-limiting embodiment of which is shown in FIGS. 4C and 4D), and a loop antenna (a non-limiting embodiment of which is shown in FIGS. 4E and 4F). Although not shown, the radio antennas might also include, without limitation, a dipole antenna or a monopole antenna, or other types of antennas, or the like.

With reference to FIGS. 4A and 4B, a parabolic reflector-based antenna 405 might have a circular dish shape as shown in FIGS. 4A and 4B, although the various embodiments are not so limited, and the parabolic reflector-based antenna may have any suitable shape or profile so long as it is able to reflect signals to a signal collector at the focal point defined by the shape of the parabolic reflector.

In some embodiments, one or more sensors 410 might be attached (either removably attached or permanently attached) to a rear surface of the parabolic reflector-based antenna 405. In some cases, the one or more sensors 410 might include, but are not limited to, a first sensor 410a, a second sensor 410b, a third sensor 410c, and a fourth sensor 410d, or the like. In some instances, the first sensor 410a and the second sensor 410b, while attached to the antenna 405, might be disposed apart from each other along a horizontal plane that is perpendicular to an optimal direction from which the antenna 405 receives signals, where the optimal direction is the direction in which the antenna 405 should point in order to maximize or optimize the signal that is received. In some cases, the third sensor 410c and the fourth sensor 410d, while attached to the antenna 405, might be disposed apart from each other along a vertical plane that is perpendicular to the optimal direction from which the antenna 405 receives signals. A computing system 415 (and optionally, a display device 420, or the like) might likewise be attached (either removably attached or permanently attached) to a rear surface of the parabolic reflector-based antenna 405. Alternative or additional to the display device 420, one or more motors might be used to automatically and/or mechanically horizontally or vertically rotate the antenna 405 about a vertical axis and/or about a horizontal axis.

In operation, the computing system 415 might receive (from a second antenna that is physically located a distance away from the antenna 405) a first signal from the first sensor 410a and a second signal from the second sensor 410b, might analyze the first signal and the second signal to determine which signal is stronger, and, based on a determination that one of the first signal and the second signal is greater than the other, might send a first output signal indicating to rotate the antenna 405 horizontally about a vertical axis toward the second antenna and might repeat the receiving and analyzing processes until a difference between the first signal and the second signal has been reduced to within a predetermined threshold similarity value. In this example, the second sensor 410b might receive a stronger signal compared to the signal received by the first sensor 410a, and thus the second signal might be greater than the first signal. The first output signal would, in this case, indicate to rotate the antenna 405 horizontally about the vertical axis, particularly to the left (as shown in the screen of the display device 420, as depicted in FIG. 4B).

Similarly, the computing system 415 might receive (from the second antenna) a third signal from the third sensor 410c and a fourth signal from the fourth sensor 410d, might analyze the third signal and the fourth signal to determine which signal is stronger, and, based on a determination that one of the third signal and the fourth signal is greater than the other, might send a second output signal indicating to rotate the antenna 405 vertically about a horizontal axis toward the second antenna and might repeat the receiving and analyzing processes until a difference between the third signal and the fourth signal has been reduced to within a predetermined threshold similarity value. In this example, the third sensor 410c might receive a stronger signal compared to the signal received by the fourth sensor 410d, and thus the third signal might be greater than the fourth signal. The second output signal would, in this case, indicate to rotate the antenna 405 vertically about the horizontal axis, particularly to tilt the antenna 405 upward (as shown in the screen of the display device 420, as depicted in FIG. 4B).

Referring to FIGS. 4C and 4D, a Yagi-Uda antenna 405′ might comprise a driven element, a reflector, and one or more directors (six being shown in FIG. 4C, but not limited to six).

According to some embodiments, one or more sensors 410 might be attached (either removably attached or permanently attached) to a rear surface of the Yagi-Uda antenna 405′. In some cases, the one or more sensors 410 might include, but are not limited to, a first sensor 410a, a second sensor 410b, a third sensor 410c, and a fourth sensor 410d, or the like. In some instances, the first sensor 410a and the second sensor 410b, while attached to the antenna 405′, might be disposed apart from each other along a horizontal plane that is perpendicular to an optimal direction from which the antenna 405′ receives signals, where the optimal direction is the direction in which the antenna 405′ should point in order to maximize or optimize the signal that is received. In some cases, the third sensor 410c and the fourth sensor 410d, while attached to the antenna 405′, might be disposed apart from each other along a vertical plane that is perpendicular to the optimal direction from which the antenna 405′ receives signals. A computing system 415 (and optionally, a display device 420, or the like) might likewise be attached (either removably attached or permanently attached) to a rear surface of the Yagi-Uda antenna 405′. Alternative or additional to the display device 420, one or more motors might be used to automatically and/or mechanically horizontally or vertically rotate the antenna 405′ about a vertical axis and/or about a horizontal axis.

In operation, the computing system 415 might receive (from a second antenna that is physically located a distance away from the antenna 405′) a first signal from the first sensor 410a and a second signal from the second sensor 410b, might analyze the first signal and the second signal to determine which signal is stronger, and, based on a determination that one of the first signal and the second signal is greater than the other, might send a first output signal indicating to rotate the antenna 405′ horizontally about a vertical axis toward the second antenna and might repeat the receiving and analyzing processes until a difference between the first signal and the second signal has been reduced to within a predetermined threshold similarity value. In this example, the first sensor 410a might receive a stronger signal compared to the signal received by the second sensor 410b, and thus the first signal might be greater than the second signal. The first output signal would, in this case, indicate to rotate the antenna 405′ horizontally about the vertical axis, particularly to the right (as shown in the screen of the display device 420, as depicted in FIG. 4D).

Similarly, the computing system 415 might receive (from the second antenna) a third signal from the third sensor 410c and a fourth signal from the fourth sensor 410d, might analyze the third signal and the fourth signal to determine which signal is stronger, and, based on a determination that one of the third signal and the fourth signal is greater than the other, might send a second output signal indicating to rotate the antenna 405′ vertically about a horizontal axis toward the second antenna and might repeat the receiving and analyzing processes until a difference between the third signal and the fourth signal has been reduced to within a predetermined threshold similarity value. In this example, the fourth sensor 410d might receive a stronger signal compared to the signal received by the third sensor 410c, and thus the fourth signal might be greater than the third signal. The second output signal would, in this case, indicate to rotate the antenna 405′ vertically about the horizontal axis, particularly to tilt the antenna 405′ downward (as shown in the screen of the display device 420, as depicted in FIG. 4D).

Turning to FIGS. 4E and 4F, a loop antenna 405″ might have a square loop shape as shown in FIGS. 4E and 4F, although the various embodiments are not so limited, and the loop antenna may have any suitable shape or profile—including, but not limited to, a circle, a triangle, a rectangle, or any polygon—so long as a closed geometric loop is formed.

In some embodiments, one or more sensors 410 might be attached (either removably attached or permanently attached) to a rear surface of the loop antenna 405″. In some cases, the one or more sensors 410 might include, but are not limited to, a first sensor 410a, a second sensor 410b, a third sensor 410c, and a fourth sensor 410d, or the like. In some instances, the first sensor 410a and the second sensor 410b, while attached to the antenna 405″, might be disposed apart from each other along a horizontal plane that is perpendicular to an optimal direction from which the antenna 405″ receives signals, where the optimal direction is the direction in which the antenna 405″ should point in order to maximize or optimize the signal that is received. In some cases, the third sensor 410c and the fourth sensor 410d, while attached to the antenna 405″, might be disposed apart from each other along a vertical plane that is perpendicular to the optimal direction from which the antenna 405″ receives signals. A computing system 415 (and optionally, a display device 420, or the like) might likewise be attached (either removably attached or permanently attached) to a rear surface of the loop antenna 405″. Alternative or additional to the display device 420, one or more motors might be used to automatically and/or mechanically horizontally or vertically rotate the antenna 405″ about a vertical axis and/or about a horizontal axis.

In operation, the computing system 415 might receive (from a second antenna that is physically located a distance away from the antenna 405″) a first signal from the first sensor 410a and a second signal from the second sensor 410b, might analyze the first signal and the second signal to determine which signal is stronger, and, based on a determination that one of the first signal and the second signal is greater than the other, might send a first output signal indicating to rotate the antenna 405″ horizontally about a vertical axis toward the second antenna and might repeat the receiving and analyzing processes until a difference between the first signal and the second signal has been reduced to within a predetermined threshold similarity value. In this example, the first sensor 410a might receive a stronger signal compared to the signal received by the second sensor 410b, and thus the first signal might be greater than the second signal. The first output signal would, in this case, indicate to rotate the antenna 405′ horizontally about the vertical axis, particularly to the right (as shown in the screen of the display device 420, as depicted in FIG. 4F).

Similarly, the computing system 415 might receive (from the second antenna) a third signal from the third sensor 410c and a fourth signal from the fourth sensor 410d, might analyze the third signal and the fourth signal to determine which signal is stronger, and, based on a determination that one of the third signal and the fourth signal is greater than the other, might send a second output signal indicating to rotate the antenna 405″ vertically about a horizontal axis toward the second antenna and might repeat the receiving and analyzing processes until a difference between the third signal and the fourth signal has been reduced to within a predetermined threshold similarity value. In this example, the third sensor 410c might receive a stronger signal compared to the signal received by the fourth sensor 410d, and thus the third signal might be greater than the fourth signal. The second output signal would, in this case, indicate to rotate the antenna 405″ vertically about the horizontal axis, particularly to tilt the antenna 405″ upward (as shown in the screen of the display device 420, as depicted in FIG. 4B).

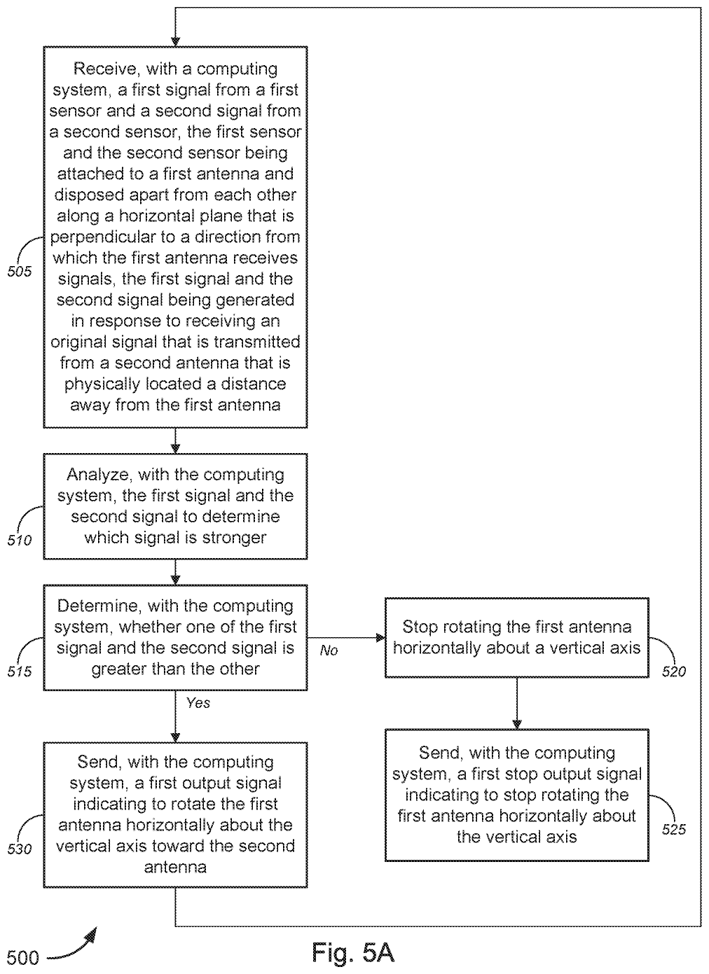

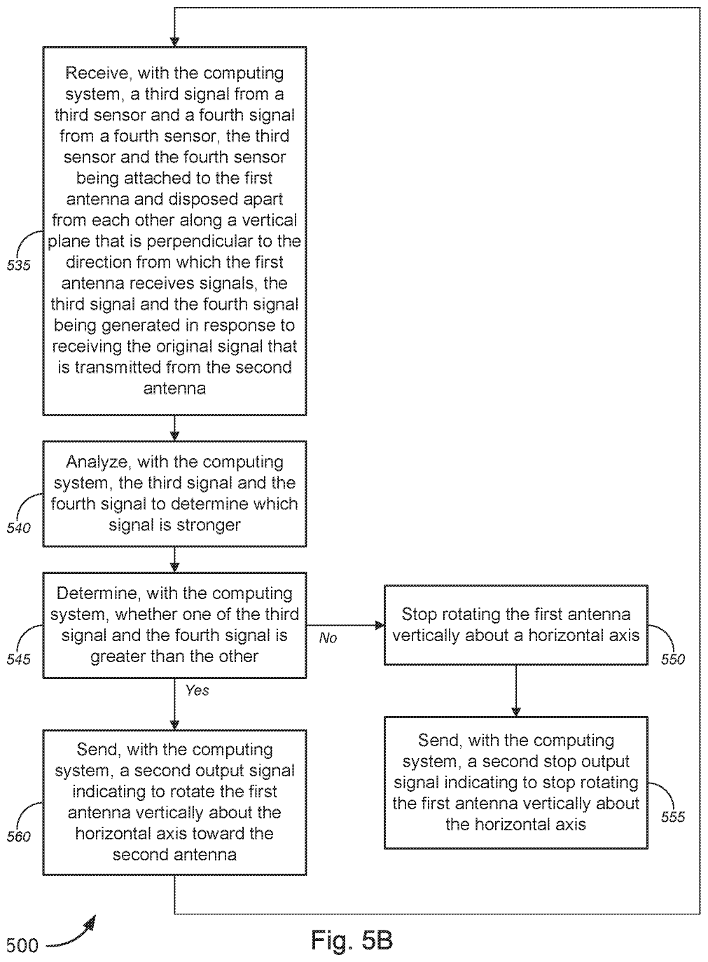

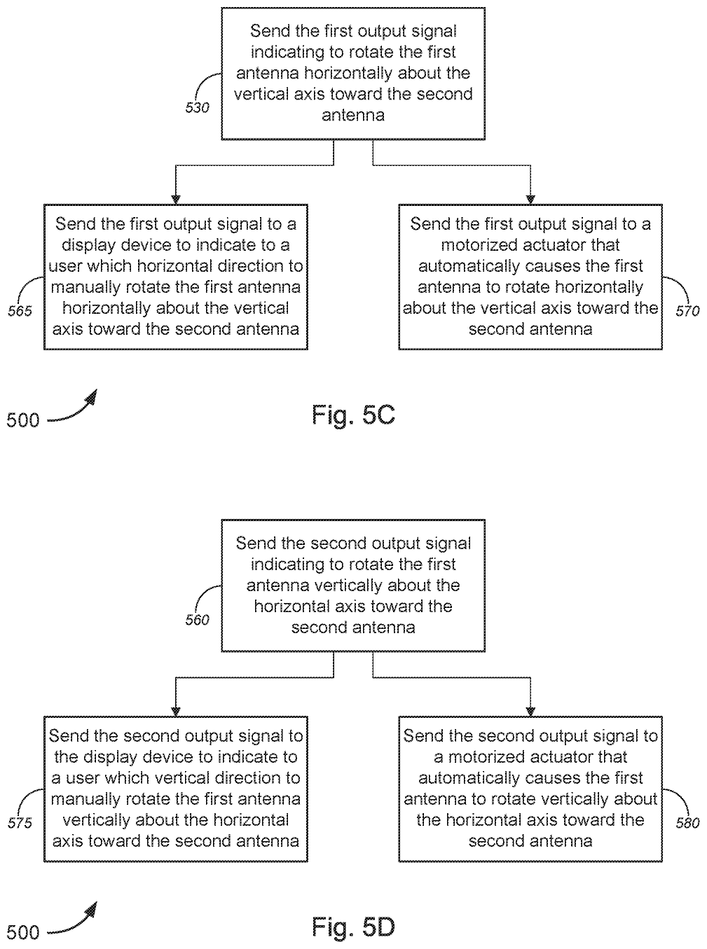

FIGS. 5A-5D (collectively, “FIG. 5”) are flow diagrams illustrating a method 500 for implementing radio antenna alignment, in accordance with various embodiments.

While the techniques and procedures are depicted and/or described in a certain order for purposes of illustration, it should be appreciated that certain procedures may be reordered and/or omitted within the scope of various embodiments. Moreover, while the method 500 illustrated by FIG. 5 can be implemented by or with (and, in some cases, are described below with respect to) the systems, embodiments, or orientations 100, 200, 200′, 300, 300′, 300″, 300″, 400, 400′, and 400″ of FIGS. 1, 2A, 2B, 3A, 3B, 3C, 3D, 4A-4B, 4C-4D, and 4E-4F respectively (or components thereof), such methods may also be implemented using any suitable hardware (or software) implementation. Similarly, while each of the systems, embodiments, or orientations 100, 200, 200′, 300, 300′, 300″, 300″, 400, 400′, and 400″ of FIGS. 1, 2A, 2B, 3A, 3B, 3C, 3D, 4A-4B, 4C-4D, and 4E-4F, respectively (or components thereof), can operate according to the method 500 illustrated by FIG. 5 (e.g., by executing instructions embodied on a computer readable medium), the systems, embodiments, or orientations 100, 200, 200′, 300, 300′, 300″, 300″, 400, 400′, and 400″ of FIGS. 1, 2A, 2B, 3A, 3B, 3C, 3D, 4A-4B, 4C-4D, and 4E-4F can each also operate according to other modes of operation and/or perform other suitable procedures.

In the non-limiting embodiment of FIG. 5A, method 500, at block 505, might comprise receiving, with a computing system, a first signal from a first sensor and a second signal from a second sensor. The first sensor and the second sensor might be attached to a first antenna and disposed apart from each other along a horizontal plane that is perpendicular to a direction from which the first antenna receives signals. The first signal and the second signal might be generated in response to receiving an original signal that is transmitted from a second antenna that is physically located a distance away from the first antenna (e.g., greater than 50 m (˜55 yards), greater than 100 m (˜109 yards), greater than 150 m (˜164 yards), greater than 200 m (˜219 yards), greater than 250 m (˜273 yards), greater than 300 m (˜328 yards), greater than 350 m (˜383 yards), greater than 400 m (˜437 yards), greater than 450 m (˜492 yards), greater than 500 m (˜547 yards), greater than 550 m (˜601 yards), greater than 600 m (˜656 yards), greater than 650 m (˜711 yards), greater than 700 m (˜766 yards), greater than 750 m (˜820 yards), greater than 800 m (˜875 yards), greater than 850 m (˜930 yards), greater than 900 m (˜984 yards), greater than 950 m (˜1,039 yards), greater than 1 km (˜1,094 yards), or greater). In some instances, the second antenna may not be in line of sight of the first antenna (and in some cases, might be visually or physically obscured by parts of buildings, trees, mountains, or other structures, and/or the like).

In some embodiments, the computing system might include, without limitation, at least one of a microprocessor, a microcontroller, a processor, a portable computer, a server, a distributed computing system, or a cloud-based computing system, and/or the like. In some cases, the first sensor and the second sensor might be radio frequency (“rf”) sensors, where the original signal might be a rf signal. According to some embodiments, the rf sensors might comprise at least one of one or more germanium diode rf detectors, one or more silicon rf detectors, one or more Schottky diode rf detectors, one or more gallium arsenide rf detectors, or one or more copper wires, and/or the like. In some instances, the first antenna (and in some cases, the second antenna as well) might include, but is not limited to, at least one of a parabolic reflector-based antenna, a Yagi-Uda antenna, a beam antenna, a parasitic array antenna, a loop antenna, a dipole antenna, or a monopole antenna, and/or the like.

Method 500 might comprise analyzing, with the computing system, the first signal and the second signal to determine which signal is stronger (block 510). In some cases, method 500 might comprise, at block 515, determining, with the computing system, whether one of the first signal and the second signal is greater than the other. If so, the method might continue onto the process at block 530. If not, the method might continue onto the process at block 520.

At block 520, method 500 might comprise stopping rotation of the first antenna horizontally about a vertical axis, in some cases, by sending, with the computing system, a first stop output signal indicating to stop rotating the first antenna horizontally about the vertical axis (block 525). At block 530, method 500 might comprise sending, with the computing system, a first output signal indicating to rotate the first antenna horizontally about the vertical axis toward the second antenna. The method might return to the process at block 505. In other words, method 500 might comprise, based on a determination that one of the first signal and the second signal is greater than the other, sending, with the computing system, the first output signal indicating to rotate the first antenna horizontally about the vertical axis toward the second antenna (at block 530), and repeating the receiving and analyzing processes (at blocks 505, 510, and 515) until a difference between the first signal and the second signal has been reduced to within a predetermined threshold similarity value (e.g., to within 1%, within 0.5%, within 0.4%, within 0.3%, within 0.2%, within 0.1%, or less, of the signal amplitude of one of the first and second signals).

According to some embodiments, horizontal radio antenna alignment as described above with respect to blocks 505-530 of FIG. 5A may be similarly applicable to vertical radio antenna alignment as shown with respect to blocks 535-560 of FIG. 5B. In particular, with reference to the non-limiting embodiment of FIG. 5B, method 500, at block 535, might comprise receiving, with the computing system, a third signal from a third sensor and a fourth signal from a fourth sensor. The third sensor and the fourth sensor might be attached to the first antenna and disposed apart from each other along a vertical plane that is perpendicular to the direction from which the first antenna receives signals. The third signal and the fourth signal might be generated in response to receiving the original signal that is transmitted from the second antenna.

Method 500 might comprise analyzing, with the computing system, the third signal and the fourth signal to determine which signal is stronger (block 540). In some cases, method 500 might comprise, at block 545, determining, with the computing system, whether one of the third signal and the fourth signal is greater than the other. If so, the method might continue onto the process at block 560. If not, the method might continue onto the process at block 550.

At block 550, method 500 might comprise stopping rotation of the first antenna vertically about a horizontal axis, in some cases, by sending, with the computing system, a second stop output signal indicating to stop rotating the first antenna vertically about the horizontal axis (block 555). At block 560, method 500 might comprise sending, with the computing system, a second output signal indicating to rotate the first antenna vertically about the horizontal axis toward the second antenna. The method might return to the process at block 535. In other words, method 500 might comprise, based on a determination that one of the third signal and the fourth signal is greater than the other, sending, with the computing system, the second output signal indicating to rotate the first antenna vertically about the horizontal axis toward the second antenna (at block 560), and repeating the receiving and analyzing processes (at blocks 535, 540, and 545) until a difference between the third signal and the fourth signal has been reduced to within the predetermined threshold similarity value (e.g., to within 1%, within 0.5%, within 0.4%, within 0.3%, within 0.2%, within 0.1%, or less, of the signal amplitude of one of the third and fourth signals).

Referring to FIG. 5C, sending the first output signal indicating to rotate the first antenna horizontally about the vertical axis toward the second antenna (at block 530) might comprise either sending the first output signal to a display device to indicate to a user which horizontal direction to manually rotate the first antenna horizontally about the vertical axis toward the second antenna (block 565) or sending the first output signal to a motorized actuator that automatically causes the first antenna to rotate horizontally about the vertical axis toward the second antenna (block 570). In a similar manner (although not shown in FIG. 5), sending the first stop output signal indicating to stop rotating the first antenna horizontally about the vertical axis (at block 525) might comprise either sending the first stop output signal to the display device to indicate to the user to manually stop rotating the first antenna horizontally about the vertical axis or sending the first stop output signal to the motorized actuator that automatically causes the first antenna to stop rotating horizontally about the vertical axis.

Turning to FIG. 5D, sending the second output signal indicating to rotate the first antenna vertically about the horizontal axis toward the second antenna (at block 560) might comprise either sending the second output signal to the display device to indicate to a user which vertical direction to manually rotate the first antenna vertically about the horizontal axis toward the second antenna (block 575) or sending the second output signal to a motorized actuator that automatically causes the first antenna to rotate vertically about the horizontal axis toward the second antenna (block 580). In a similar manner (although not shown in FIG. 5), sending the second stop output signal indicating to stop rotating the first antenna vertically about the horizontal axis (at block 555) might comprise either sending the second stop output signal to the display device to indicate to the user to manually stop rotating the first antenna vertically about the horizontal axis or sending the second stop output signal to the motorized actuator that automatically causes the first antenna to stop rotating vertically about the horizontal axis.

Exemplary System and Hardware Implementation

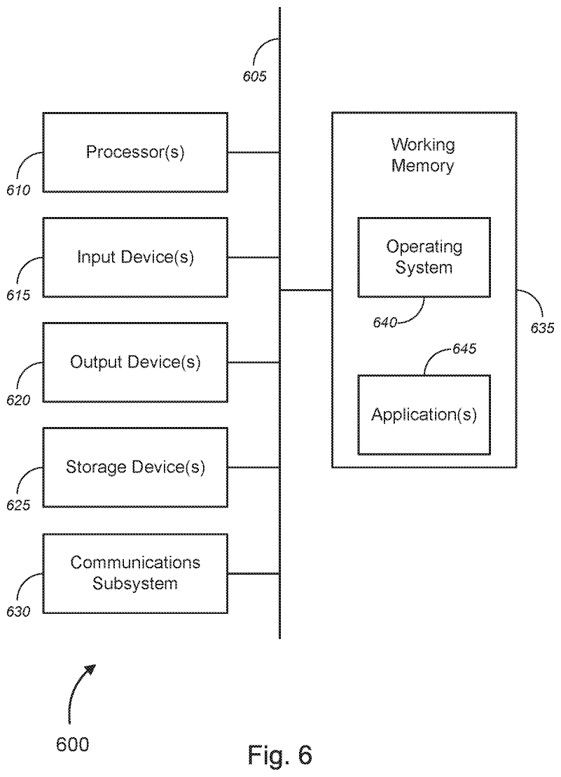

FIG. 6 is a block diagram illustrating an exemplary computer or system hardware architecture, in accordance with various embodiments. FIG. 6 provides a schematic illustration of one embodiment of a computer system 600 of the service provider system hardware that can perform the methods provided by various other embodiments, as described herein, and/or can perform the functions of computer or hardware system (i.e., computing systems 120, 320, and 415, remote computing system 135, etc.), as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600—which might represent an embodiment of the computer or hardware system (i.e., computing systems 120, 320, and 415, remote computing system 135, etc.), described above with respect to FIGS. 1-5—is shown comprising hardware elements that can be electrically coupled via a bus 605 (or may otherwise be in communication, as appropriate). The hardware elements may include one or more processors 610, including, without limitation, one or more general-purpose processors and/or one or more special-purpose processors (such as microprocessors, digital signal processing chips, graphics acceleration processors, and/or the like); one or more input devices 615, which can include, without limitation, a mouse, a keyboard, and/or the like; and one or more output devices 620, which can include, without limitation, a display device, a printer, and/or the like.

The computer or hardware system 600 may further include (and/or be in communication with) one or more storage devices 625, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 600 might also include a communications subsystem 630, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further comprise a working memory 635, which can include a RAM or ROM device, as described above.

The computer or hardware system 600 also may comprise software elements, shown as being currently located within the working memory 635, including an operating system 640, device drivers, executable libraries, and/or other code, such as one or more application programs 645, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire, and fiber optics, including the wires that comprise the bus 605, as well as the various components of the communication subsystem 630 (and/or the media by which the communications subsystem 630 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

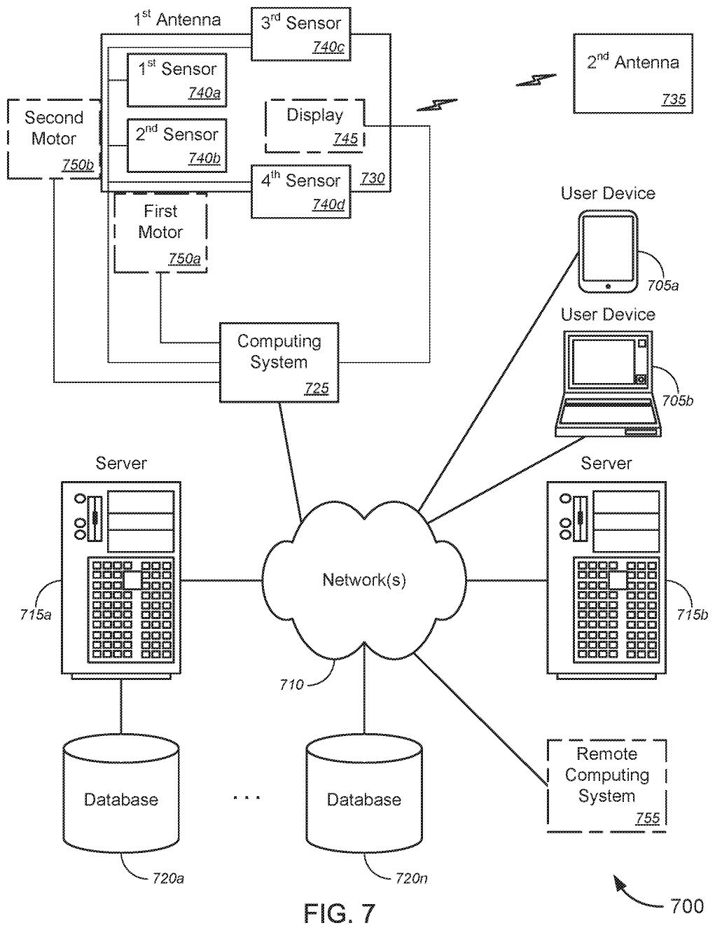

As noted above, a set of embodiments comprises methods and systems for implementing radio antenna alignment, and, more particularly, to methods, systems, and apparatuses for implementing non-line-of-sight radio antenna alignment. FIG. 7 illustrates a schematic diagram of a system 700 that can be used in accordance with one set of embodiments. The system 700 can include one or more user computers, user devices, or customer devices 705. A user computer, user device, or customer device 705 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 705 can also have any of a variety of applications, including one or more applications configured to perform methods provided by various embodiments (as described above, for example), as well as one or more office applications, database client and/or server applications, and/or web browser applications. Alternatively, a user computer, user device, or customer device 705 can be any other electronic device, such as a thin-client computer, Internet-enabled mobile telephone, and/or personal digital assistant, capable of communicating via a network (e.g., the network(s) 710 described below) and/or of displaying and navigating web pages or other types of electronic documents. Although the exemplary system 700 is shown with two user computers, user devices, or customer devices 705, any number of user computers, user devices, or customer devices can be supported.

Certain embodiments operate in a networked environment, which can include a network(s) 710. The network(s) 710 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network(s) 710 (similar to network(s) 140 FIG. 1, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 715. Each of the server computers 715 may be configured with an operating system, including, without limitation, any of those discussed above, as well as any commercially (or freely) available server operating systems. Each of the servers 715 may also be running one or more applications, which can be configured to provide services to one or more clients 705 and/or other servers 715.

Merely by way of example, one of the servers 715 might be a data server, a web server, a cloud computing device(s), or the like, as described above. The data server might include (or be in communication with) a web server, which can be used, merely by way of example, to process requests for web pages or other electronic documents from user computers 705. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 705 to perform methods of the invention.

The server computers 715, in some embodiments, might include one or more application servers, which can be configured with one or more applications accessible by a client running on one or more of the client computers 705 and/or other servers 715. Merely by way of example, the server(s) 715 can be one or more general purpose computers capable of executing programs or scripts in response to the user computers 705 and/or other servers 715, including, without limitation, web applications (which might, in some cases, be configured to perform methods provided by various embodiments). Merely by way of example, a web application can be implemented as one or more scripts or programs written in any suitable programming language, such as Java™, C, C #™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 705 and/or another server 715. In some embodiments, an application server can perform one or more of the processes for implementing radio antenna alignment, and, more particularly, to methods, systems, and apparatuses for implementing non-line-of-sight radio antenna alignment, as described in detail above. Data provided by an application server may be formatted as one or more web pages (comprising HTML, JavaScript, etc., for example) and/or may be forwarded to a user computer 705 via a web server (as described above, for example). Similarly, a web server might receive web page requests and/or input data from a user computer 705 and/or forward the web page requests and/or input data to an application server. In some cases, a web server may be integrated with an application server.

In accordance with further embodiments, one or more servers 715 can function as a file server and/or can include one or more of the files (e.g., application code, data files, etc.) necessary to implement various disclosed methods, incorporated by an application running on a user computer 705 and/or another server 715. Alternatively, as those skilled in the art will appreciate, a file server can include all necessary files, allowing such an application to be invoked remotely by a user computer, user device, or customer device 705 and/or server 715.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 720a-720n (collectively, “databases 720”). The location of each of the databases 720 is discretionary: merely by way of example, a database 720a might reside on a storage medium local to (and/or resident in) a server 715a (and/or a user computer, user device, or customer device 705). Alternatively, a database 720n can be remote from any or all of the computers 705, 715, so long as it can be in communication (e.g., via the network 710) with one or more of these. In a particular set of embodiments, a database 720 can reside in a storage-area network (“SAN”) familiar to those skilled in the art. (Likewise, any necessary files for performing the functions attributed to the computers 705, 715 can be stored locally on the respective computer and/or remotely, as appropriate.) In one set of embodiments, the database 720 can be a relational database, such as an Oracle database, that is adapted to store, update, and retrieve data in response to SQL-formatted commands. The database might be controlled and/or maintained by a database server, as described above, for example.

According to some embodiments, system 700 might further comprise a computing system 725 (similar to computing systems 120, 320, and 415 of FIGS. 1, 3, and 4, or the like), a first antenna 730 (similar to first antenna 105, 305, 405, 405′, and 405″ of FIGS. 1, 3, 4A-4B, 4C-4D, and 4E-4F, or the like), a second antenna 735 (similar to second antenna 110 and 310 of FIGS. 1 and 3, or the like), sensors 740a-740d (similar to sensors 115a-115d, 205, 205′, 315a-315d, and 410a-410d of FIGS. 1, 2A, 2B, 3, and 4, or the like), display device 745 (optional; similar to display device 125 of FIG. 1, or the like), first and second motors 750a and 750b (optional; similar to motors 130a and 130b of FIG. 1, or the like), and remote computing system 755 (optional; similar to remote computing system 135 of FIG. 1, or the like), and/or the like.

In operation, the computing system 725 might receive (from the second antenna 735 that is physically located a distance away from the first antenna 730) a first signal from the first sensor 740a and a second signal from the second sensor 740b, might analyze the first signal and the second signal to determine which signal is stronger, and, based on a determination that one of the first signal and the second signal is greater than the other, might send a first output signal indicating to rotate the first antenna 730 horizontally about a vertical axis toward the second antenna 735 and might repeat the receiving and analyzing processes until a difference between the first signal and the second signal has been reduced to within a predetermined threshold similarity value (e.g., to within 1%, within 0.5%, within 0.4%, within 0.3%, within 0.2%, within 0.1%, or less, of the signal amplitude of one of the first and second signals).

Similarly, the computing system 725 might receive (from the second antenna 735) a third signal from the third sensor 740c and a fourth signal from the fourth sensor 740d, might analyze the third signal and the fourth signal to determine which signal is stronger, and, based on a determination that one of the third signal and the fourth signal is greater than the other, might send a second output signal indicating to rotate the first antenna 730 vertically about a horizontal axis toward the second antenna 735 and might repeat the receiving and analyzing processes until a difference between the third signal and the fourth signal has been reduced to within a predetermined threshold similarity value (e.g., to within 1%, within 0.5%, within 0.4%, within 0.3%, within 0.2%, within 0.1%, or less, of the signal amplitude of one of the first and second signals).

These and other functions of the system 700 (and its components) are described in greater detail above with respect to FIGS. 1-5.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a computing system, a first signal from a first sensor and a second signal from a second sensor, the first sensor and the second sensor being attached to a first antenna and disposed apart from each other along a horizontal plane that is perpendicular to a direction from which the first antenna receives signals, the first signal and the second signal being generated in response to receiving an original signal that is transmitted from a second antenna that is physically located a distance away from the first antenna;
analyzing, with the computing system, the first signal and the second signal to determine which signal is stronger; and
based on a determination that one of the first signal and the second signal is greater than the other, sending, with the computing system, a first output signal indicating to rotate the first antenna horizontally about a vertical axis toward the second antenna, and repeating the receiving and analyzing processes until a difference between the first signal and the second signal has been reduced to within a predetermined threshold similarity value.

2. The method of claim 1, wherein the computing system comprises at least one of a microprocessor, a microcontroller, a processor, a portable computer, a server, a distributed computing system, or a cloud-based computing system.

3. The method of claim 1, wherein the first sensor and the second sensor are radio frequency (“rf”) sensors and wherein the original signal is a rf signal.

4. The method of claim 1, wherein sending the first output signal comprises sending the first output signal to a display device to indicate to a user which horizontal direction to manually rotate the first antenna horizontally about the vertical axis toward the second antenna.

5. The method of claim 1, wherein sending the first output signal comprises sending the first output signal to a motorized actuator that automatically causes the first antenna to rotate horizontally about the vertical axis toward the second antenna.

6. The method of claim 1, further comprising:
receiving, with the computing system, a third signal from a third sensor and a fourth signal from a fourth sensor, the third sensor and the fourth sensor being attached to the first antenna and disposed apart from each other along a vertical plane that is perpendicular to the direction from which the first antenna receives signals, the third signal and the fourth signal being generated in response to receiving the original signal that is transmitted from the second antenna;
analyzing, with the computing system, the third signal and the fourth signal to determine which signal is stronger; and
based on a determination that one of the third signal and the fourth signal is greater than the other, sending, with the computing system, a second output signal indicating to rotate the first antenna vertically about a horizontal axis toward the second antenna, and repeating the receiving and analyzing processes until a difference between the third signal and the fourth signal has been reduced to within the predetermined threshold similarity value.

7. The method of claim 6, wherein sending the second output signal comprises sending the second output signal to a display device to indicate to a user which vertical direction to manually rotate the first antenna vertically about the horizontal axis toward the second antenna.

8. The method of claim 6, wherein sending the second output signal comprises sending the second output signal to a motorized actuator that automatically causes the first antenna to rotate vertically about the horizontal axis toward the second antenna.

9. The method of claim 1, wherein the second antenna is not in line of sight of the first antenna.

10. An antenna alignment device, comprising:
at least one processor; and
a non-transitory computer readable medium communicatively coupled to the at least one processor, the non-transitory computer readable medium having stored thereon computer software comprising a set of instructions that, when executed by the at least one processor, causes the antenna alignment device to:
receive a first signal from a first sensor and a second signal from a second sensor, the first sensor and the second sensor being attached to a first antenna and disposed apart from each other along a horizontal plane that is perpendicular to a direction from which the first antenna receives signals, the first signal and the second signal being generated in response to receiving an original signal that is transmitted from a second antenna that is physically located a distance away from the first antenna;
analyze the first signal and the second signal to determine which signal is stronger; and
based on a determination that one of the first signal and the second signal is greater than the other, send a first output signal indicating to rotate the first antenna horizontally about a vertical axis toward the second antenna, and repeat the receiving and analyzing processes until a difference between the first signal and the second signal has been reduced to within a predetermined threshold similarity value.

11. The antenna alignment device of claim 10, wherein the antenna alignment device comprises at least one of a microprocessor, a microcontroller, a processor, a portable computer, a server, a distributed computing system, or a cloud-based computing system.

12. The antenna alignment device of claim 10, wherein the first sensor and the second sensor are radio frequency (“rf”) sensors and wherein the original signal is a rf signal.

13. The antenna alignment device of claim 12, wherein the rf sensors comprise at least one of one or more germanium diode rf detectors, one or more silicon rf detectors, one or more Schottky diode rf detectors, one or more gallium arsenide rf detectors, or one or more copper wires.

14. The antenna alignment device of claim 12, wherein the first antenna comprises at least one of a parabolic reflector-based antenna, a Yagi-Uda antenna, a beam antenna, a parasitic array antenna, a loop antenna, a dipole antenna, or a monopole antenna.

15. The antenna alignment device of claim 10, wherein sending the first output signal comprises sending the first output signal to a display device to indicate to a user which horizontal direction to manually rotate the first antenna horizontally about the vertical axis toward the second antenna.

16. The antenna alignment device of claim 10, wherein sending the first output signal comprises sending the first output signal to a motorized actuator that automatically causes the first antenna to rotate horizontally about the vertical axis toward the second antenna.

17. The antenna alignment device of claim 10, wherein the set of instructions, when executed by the at least one processor, further causes the apparatus to:
receive a third signal from a third sensor and a fourth signal from a fourth sensor, the third sensor and the fourth sensor being attached to the first antenna and disposed apart from each other along a vertical plane that is perpendicular to the direction from which the first antenna receives signals, the third signal and the fourth signal being generated in response to receiving the original signal that is transmitted from the second antenna;
analyze the third signal and the fourth signal to determine which signal is stronger; and
based on a determination that one of the third signal and the fourth signal is greater than the other, send a second output signal indicating to rotate the first antenna vertically about a horizontal axis toward the second antenna, and repeat the receiving and analyzing processes until a difference between the third signal and the fourth signal has been reduced to within the predetermined threshold similarity value.

18. The antenna alignment device of claim 17, sending the second output signal comprises sending the second output signal to a display device to indicate to a user which vertical direction to manually rotate the first antenna vertically about the horizontal axis toward the second antenna.

19. The antenna alignment device of claim 17, wherein sending the second output signal comprises sending the second output signal to a motorized actuator that automatically causes the first antenna to rotate vertically about the horizontal axis toward the second antenna.

20. An antenna alignment system, comprising:
a first sensor;
a second sensor; and
a computing system, comprising:
at least one processor; and
a non-transitory computer readable medium communicatively coupled to the at least one processor, the non-transitory computer readable medium having stored thereon computer software comprising a set of instructions that, when executed by the at least one processor, causes the computing system to:
receive a first signal from the first sensor and a second signal from the second sensor, the first sensor and the second sensor being attached to a first antenna and disposed apart from each other along a horizontal plane that is perpendicular to a direction from which the first antenna receives signals, the first signal and the second signal being generated in response to receiving an original signal that is transmitted from a second antenna that is physically located a distance away from the first antenna;
analyze the first signal and the second signal to determine which signal is stronger; and
based on a determination that one of the first signal and the second signal is greater than the other, send a first output signal indicating to rotate the first antenna horizontally about a vertical axis toward the second antenna, and repeat the receiving and analyzing processes until a difference between the first signal and the second signal has been reduced to within a predetermined threshold similarity value.
